(19) United States
(12) Patent Application Publication
(10) Pub. No.: US 2014/0365254 A1
(43) Pub. Date: Dec. 11, 2014

(54) First to File Lean Invention Process

(71) Applicant: Conley Giles, Austin, TX (US)

(72) Inventor: Conley Giles, Austin, TX (US)

(21) Appl. No.: 14/217,481

(22) Filed: Mar. 18, 2014

Related U.S. Application Data
(60) Provisional application No. 61/852,608, filed on Mar. 18, 2013.

(51) Int. Cl. G06Q 50/18; G06Q 30/02; G06Q 10/06

(52) U.S. Cl. CPC G06Q 50/184; G06Q 10/06311; G06Q 30/0201
USPC 705/7.13

(57) ABSTRACT

Systems and methods are disclosed to commercialize a product or service at an early stage, by conceiving of a new concept and converting the new concept into an intellectual property (IP) asset; forming a team to develop the new concept using a computer; determining contributions from each member of the team and assigning a profit sharing percentage to each contributing member; and developing the new concept and bringing the product or service to a marketplace as a new business venture.

This application claims priority to Provisional Application Ser. No. 61/852,608 filed on Mar. 18, 2013, the content of which is incorporated by reference.

### BACKGROUND

The present invention pertains to a first to file rapid invention process.

In the past invention in the U.S. is generally defined to comprise two steps: (1) conception of the invention and (2) reduction to practice of the invention. When an inventor conceives of an invention and diligently reduces the invention to practice (by filing a patent application, by practicing the invention, etc.), the inventor's date of invention will be the date of conception. Thus, provided an inventor is diligent in actually reducing an application to practice, he or she will be the first inventor and the inventor entitled to a patent, even if another files a patent application, constructively reducing the invention to practice, before the inventor. However, the first applicant to file has the prima facie right to the grant of a patent. Should a second patent application be filed for the same invention, the second applicant can institute interference proceedings to determine who was the first inventor and thereby who is entitled to the grant of a patent. Interference can be an expensive and time consuming process.

In a first to file system, the right to the grant of a patent for a given invention lies with the first person to file a patent application for protection of that invention, regardless of the date of actual invention.

With the America Invents Act of 2011, which was signed by President Obama on Sep. 16, 2011. The law will switch U.S. right to the patent from the present “first to invent” system to a “first inventor to file” system for patent applications filed on or after Mar. 16, 2013.

Independent Inventors are now at a disadvantage if they are to continue to use the practices listed above, which have been standard practice for decades. Now companies with research and development teams can develop an invention at a much faster pace than the independent inventors and quickly file a Provisional Patent Application. This has created the need for a process that enables an independent inventor to create his own affinity or virtual research and development team, have the processes in place that create a similar level of trust, security and project management processes of a business or corporate research and development team.

### SUMMARY

In one aspect, systems and methods are disclosed to commercialize a product or service at an early stage, by conceiving of a new concept and converting the new concept into an intellectual property (IP) asset; forming a team to develop the new concept using a computer; determining contributions from each member of the team and assigning a profit sharing percentage to each contributing member; and developing the new concept and bringing the product or service to a marketplace as a new business venture.

Implementations of the above system and method can include one or more of the following. The First to File Lean Invention Process includes providing a series of legal documents to create the necessary level of commitment and legal obligation on the part of all the participants. The system also provides a Provisional Patent Questionnaire to initiate the patent application process requesting the title of the invention, the background of the invention, a summary of the invention and an abstract in addition to drawings and their description. The revenue sharing calculators lets the inventor and his affinity or virtual research and development team see what they each stand to earn based on the value of their contribution to the project. The calculator can also assist in determining a pre-money and pre-marketing value of the actual invention. The inventor can then reach out to a database of collaborators and manufacturers to design, develop, test, manufacture, market, distribute, and sell the product. This is all done at a much lower risk of resources including time and financial risk. The invention can then be pushed out via crowd funding using traditional sites or utilizing the Early Adopters Sales Engine “EASE” to determine if there is a viable market for the invention prior to going into production.

Other implementations of the above aspect may include one or more of the following. The process can include of one or more of the process. 1. Collaborative agreement can be accomplished by a standardized set of contracts and agreements which are addressed prior to disclosure of the intellectual property or idea. 2. The Invention Revenue Sharing calculator can accomplish several things including but not limited to a). determining the value contributed to the development of the invention b). determining the revenue share for the inventor(s), collaborator(s), investor(s) and other contributors, c). calculating the projected revenue based on annual sales, d) and calculating the revenue to be distributed to each of the inventor(s), collaborator(s), investor(s) and other contributors on a daily, weekly, annual, or life of the IP basis. 3). The Invention Matrix which is an interactive suite of web based tools that can allow for the online collaboration, development, design, prototyping, testing, production sourcing, management, marketing, sales, shipping, and fulfillment of the invention. 4). The Early Adopters Sales Engine software creates a financial incentive to an early adopter by dynamically ratcheting down the price paid by the earlier adopters as the volume of sales to the consumer or retailer based on a specific quantity or manufacturing time frame being filled. As the sales volume increases after one commits to purchase the more the price originally committed to is lowered dynamically. This can be done based on the individual purchases or based on predetermined quantities. The savings can be passed on in the form of cash refund, rebates, or credits for future purchases.

Various aspects and embodiments of the invention are described in further detail below.

### BRIEF DESCRIPTION

The present invention described herein will become apparent from the following detailed description considered in connection with the accompanying drawings, which disclose several embodiments of the invention. It should be understood, however, that the drawings are designed for the purpose of illustration and not as limits of the invention.

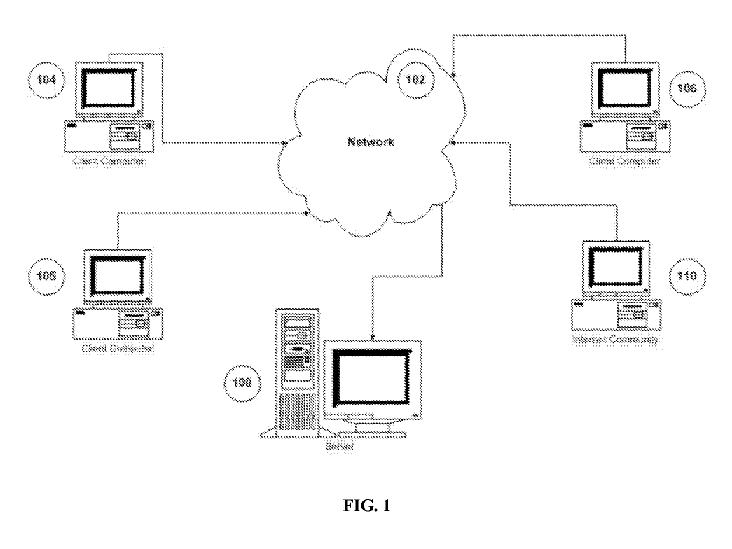

FIG. 1 shows a computer network for commercializing new ideas and inventions.

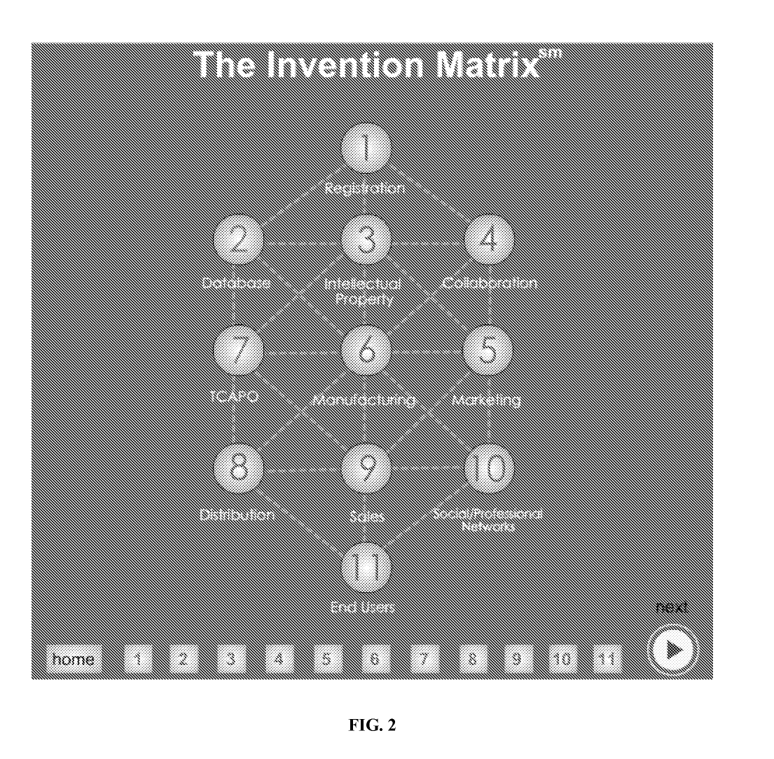

FIG. 2 shows an exemplary Invention Matrix representing many of the steps involved in the process.

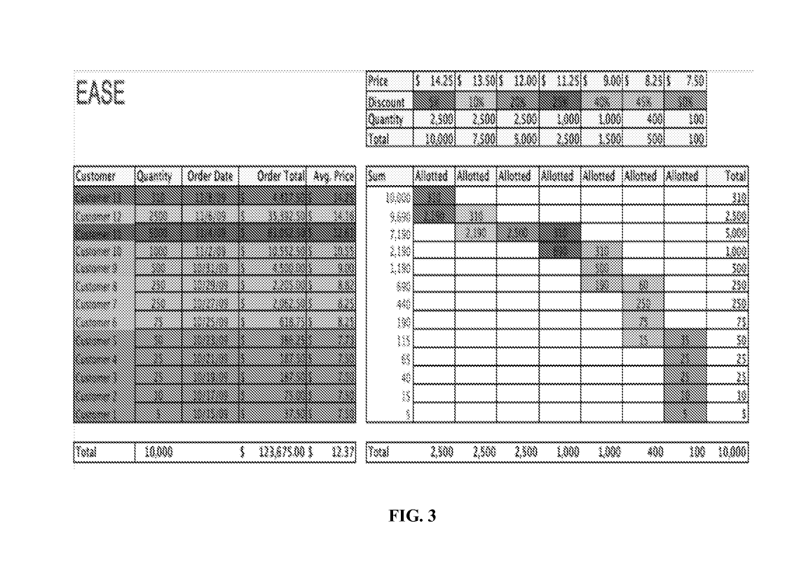

FIG. 3 shows an exemplary Early Adopter Sales Engine.

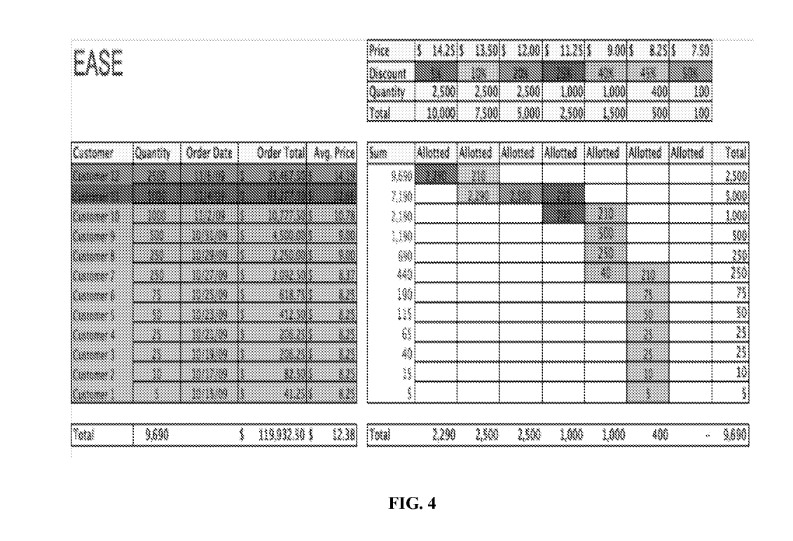

FIG. 4 shows an Early Adopter Sales Engine Example.

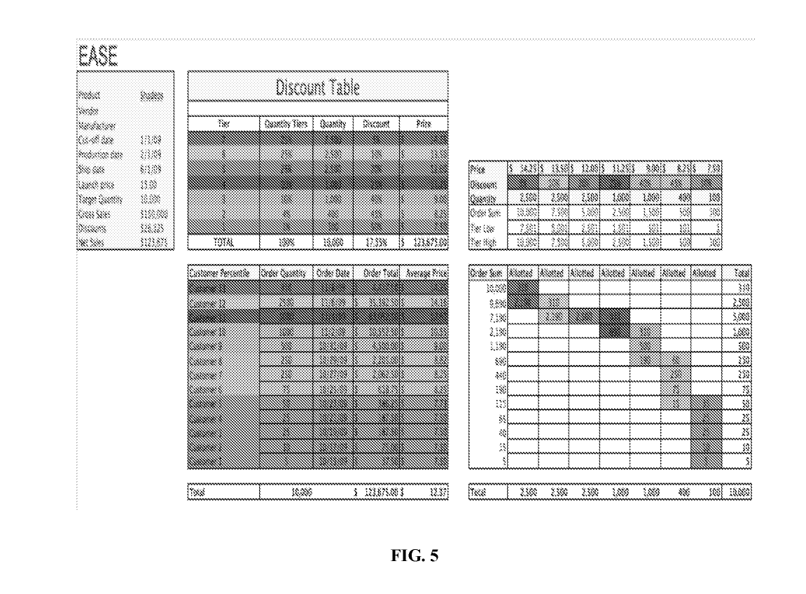

FIG. 5 shows an exemplary customer breakdown and pricing reduction based on early adoption.

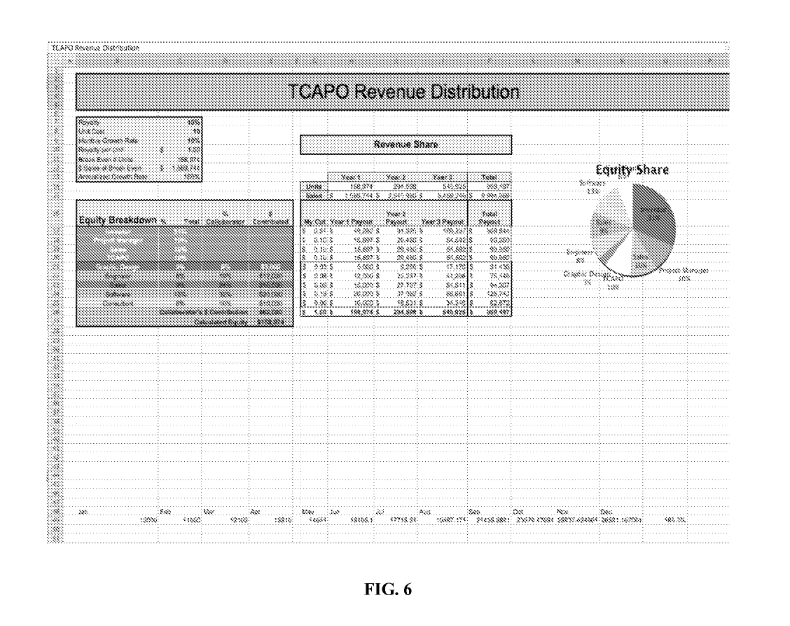

FIG. 6 shows one Standardized Formula for determining the prelaunch value of an invention and collaborators revenue shares.

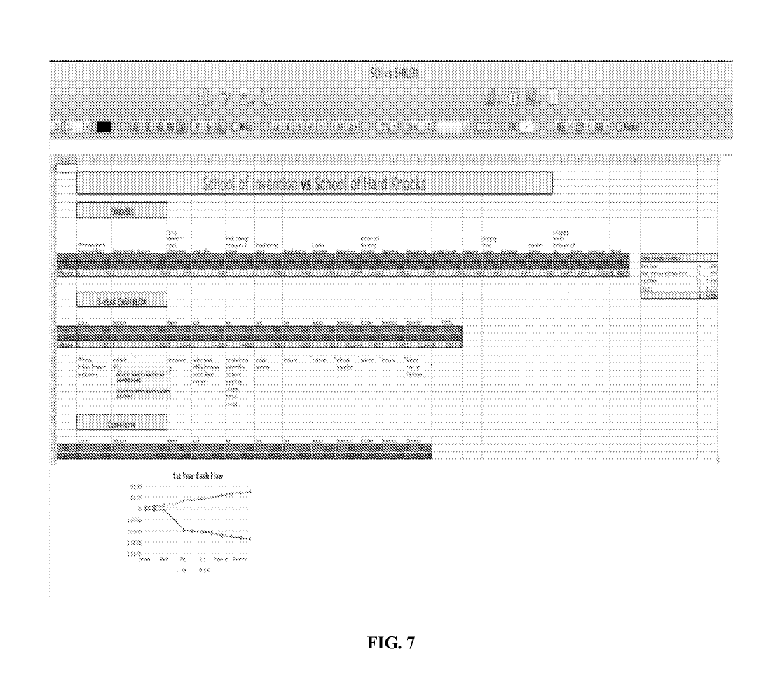

FIG. 7 School of Invention vs School of Hard Knocks shows the startup business model versus the licensing model comparison.

### DETAILED DESCRIPTION

FIG. 1 shows a computer network for commercializing new ideas and inventions. A server 100 is connected to a network 102 such as the Internet. One or more client workstations 104-106 are also connected to the network 102. The client workstations 104-106 can be personal computers, thin clients, or workstations running browsers such as Firefox or Internet Explorer. With the browser, a client or user can access the server 100's Web site by clicking in the browser's Address box, and typing the address (for example, www.mailrancher.com), then press Enter. When the page has finished loading, the status bar at the bottom of the window is updated. The browser also provides various buttons that allow the client or user to traverse the Internet or to perform other browsing functions.

An Internet community 110 with one or more service providers, manufacturers, or marketers is connected to the network 102 and can communicate directly with users of the client workstations 104-106 or indirectly through the server 100. The Internet community 110 provides the client workstations 104-106 with access to the Web for commerce.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a cluster of servers or server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 supports a document generating portal that provides a single point of integration, access, and navigation through the multiple enterprise systems and information sources facing knowledge users operating the client workstations 104-106. The portal can additionally support services that are transaction driven. Once such service is advertising: each time the user accesses the portal, the client workstation 104 or 106 downloads information from the server 100. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Additionally, the portal offers contents and forums providing focused articles, valuable insights, questions and answers, and value-added information. Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

FIG. 2 shows an exemplary Invention Matrix, which is an interactive suite of web based tools and resources pertaining to the registration and membership, database of the participants, intellectual property resources, marketing resources, manufacturing and sourcing resources, trademark copyright and patent owners resources and management, distribution resources, sales resources, social and professional network resources, and crowdsourcing and crowdfunding to end users and wholesale.

FIG. 3 shows an exemplary Early Adopter Sales Engine.

This diagram shows a customer breakdown and pricing reduction based on early adoption. The Early Adopters Sales Engine software creates a financial incentive to an early adopter by dynamically ratcheting down the price paid by the earlier adopters as the volume of sales to the consumer or retailer based on a specific quantity or manufacturing time frame being filled. As the sales volume increases after one commits to purchase the more the price originally committed to is lowered dynamically. This can be done based on the individual purchases or based on predetermined quantities. The savings can be passed on in the form of cash refund, rebates, or credits for future purchases.

FIG. 4 shows an Early Adopter Sales Engine Example. This diagram shows a customer breakdown and pricing reduction based on early adoption. The Early Adopters Sales Engine software creates a financial incentive to an early adopter by dynamically ratcheting down the price paid by the earlier adopters as the volume of sales to the consumer or retailer based on a specific quantity or manufacturing time frame being filled. As the sales volume increases after one commits to purchase the more the price originally committed to is lowered dynamically. This can be done based on the individual purchases or based on predetermined quantities. The savings can be passed on in the form of cash refund, rebates, or credits for future purchases.

FIG. 5 shows a customer breakdown and pricing reduction based on early adoption. The Early Adopters Sales Engine software creates a financial incentive to an early adopter by dynamically ratcheting down the price paid by the earlier adopters as the volume of sales to the consumer or retailer based on a specific quantity or manufacturing time frame being filled. As the sales volume increases after one commits to purchase the more the price originally committed to is lowered dynamically. This can be done based on the individual purchases or based on predetermined quantities. The savings can be passed on in the form of cash refund, rebates, or credits for future purchases.

One of the biggest challenges for an inventor or entrepreneur how to go about producing an initial manufacturing run of an product, idea or invention. The challenges include the funds to produce the tooling for the product; having orders to fulfill once the item is produced, how many units of the item to produce, the purchase of the raw materials and their costs, labor and assembly costs, consumer packaging design and production, case packs and master packs, bar coding, insurance, warehousing, marketing, advertising, sales and distribution.

Often times due to limitations of funding the product is initially produced in very small quantities significantly increasing all of the related costs. This ultimately means that the customers that are early adopters of the idea will have to pay a premium due to the higher costs associated with the initial production run. Retail buyers for large chains will often pass on a product until the entrepreneur can get his product to an acceptable price point. Many startups have to focus on independent retailers and small chains to keep their orders manageable while they build their customer base. Buying cooperatives often develop among smaller to mid size retailers in order to establish buying power to reduce their wholesale costs. Buyers are also often looking for early payment discounts typically 2% net 10 on a 30-90 day invoice.

Crowd funding has emerged in recent years allowing inventors, entrepreneurs and artists to book enough orders from individuals to justify an initial production run. This trend has enabled billions of dollars in funding for fledgling inventors, entrepreneurs and artists. Many of these individuals are approached by retailers for larger quantities and packaged product suitable for retail. Most of these entrepreneurs, inventors and artists are not prepared for this type of sale or inquiry.

With the rapid adoption of crowd funding by consumers the need for a viable platform for larger quantity crowd funding with an incentive for early adoption has emerged. The early adopters sales engine will fill that need. This system addresses this need by allowing the entrepreneur who has established a bonafide manufacturing arrangement to post their product via this web based technology. The entrepreneur can then market their product in a similar fashion to traditional crowd funding with additional incentives for early adopters. The entrepreneur can also market to a wholesale marketplace based on larger volume.

The motivation for individual and retail buyers to be an early adopter is established in the following way. The entrepreneur enters the relevant information pertaining to the products as in traditional crowd funding which may include a marketing video describing the product, promotional information, and any relevant information pertaining to the product. The entrepreneur or inventor would then enter the discount percentages for each tier and the quantity of product associated with each tier into the sales engine. The production lead times, and quantity tiers based on the manufacturing quotes for the related quantities.

The price paid by early purchasers will be ratcheted down based on the volume of sales which happen after each buyer makes their purchase. The quantities and related costs are established with the manufacturer. The corresponding discounts based on the larger quantity production runs are then entered into the early adopter sales engine. When setting up the Discount Tables within the engine the pricing structure cascades downward as the volume of sales climbs upward. The calculation of the price lowering to benefit the earlier customers as the volume increases as more customers commit to purchase is the financial incentive to commit to purchase early. The quantities are always in correlation to the pricing related to said quantity with the preferred profit margin built in at each tier.
Once the agreed upon quantities and/or timeframes are reached the agreed upon payment method could be triggered. Production could then be initiated as per the agreement.

FIG. 5 shows a customer breakdown and pricing reduction based on early adoption. The Early Adopters Sales Engine software creates a financial incentive to an early adopter by dynamically ratcheting down the price paid by the earlier adopters as the volume of sales to the consumer or retailer based on a specific quantity or manufacturing time frame being filled. As the sales volume increases after one commits to purchase, the more the price originally committed to is lowered dynamically. This can be done based on the individual purchases or based on predetermined quantities. The savings can be passed on in the form of cash refund, rebates, or credits for future purchases. Next, exemplary data for one new idea/invention as viewed through EASE, the Early adopters sales engine is shown:

| | |
|---|---|
| Product: Shadeos | The product name is entered into the program |
| Vendor: | The vendor name is entered into the program |
| Manufacturer: | The manufacturer name is entered into the program |
| Cut-off date: 1/1/09 | The cut-off date for the last order to for this production run |
| Production date: 2/1/09 | The beginning production date for the order accumulated in the |
| | program |
| Ship date: 6/1/09 | The date the product is packaged and ready to ship to fulfill |
| | orders accumulated in the program |
| Launch price: $15.00 | The standard wholesale the product is offered prior to any |
| | discounts for participating in the program |
| Target Quantity: 10,000 | The target quantity is set based on expectations and optimal |
| | production to accomplish launch price. |
| Gross Sales: $150,000 | The pre-discounted gross sales based on target quantity. |
| Discounts: $26,325 | The total discounts given based on the early adopters incentive |
| | formula entered into the program. |
| Net Sales: $123,675 | The net sales for the units ordered less the discounts for early |
| | adopters. |
| Discount Table | The table showing Tiers, Quantity Tiers, Quantity, Discount, Price |
| Tier 7 | Represents 25% of the production, 2500 units, 5% discount, |
| | $14.25 price |
| Tier 6 | Represents 25% of the production, 2500 units, 10% discount, |
| | $13.50 price |
| Tier 5 | Represents 25% of the production, 2500 units, 20% discount, |
| | $12.00 price. |
| Tier 4 | Represents 10% of the production, 1000 units, 25% discount, |
| | $11.25 price. |
| Tier 3 | Represents 10% of the production, 1000 units, 40% discount, $9.00 |
| | price. |
| Tier 2 | Represents 4% of the production, 400 units, 45% discount, $8.25 |
| | price |
| Tier 1 | Represents 1% of the production, 100 units, 50% discount, |
| | $7.50 price. |
| Customer Percentile | Represents the order in which the buyer committed to their |
| | purchase. |
| Order Quantity | Represents the quantity the buyer committed to their purchase. |
| Order Date | Represents the date the buyer committed to their purchase. |
| Order Total | Represents the total dollar amount the buyer committed to with |
| | their purchase. |
| Average Price | Represents the price per unit the buyer committed to with their |
| | purchase. |

Example: All customers enter at tier 7, once the quantity of 2500 is filled they are ratcheted down into tier 6,
Customer 1 entered tier 7 on Oct. 15, 2009 ordered 5 units at $14.25 each. As customers 2-13 entered their orders customer 1 was ratcheted down through tiers 7, 6, 5, 4, 3, 2, and into tier 1 at $7.50 per unit.
Customer 8 entered tier 7 on Oct. 29, 2009 ordered 250 units at $14.25 each. As customers 9-13 entered their orders customer 8 was ratcheted down through tiers 7, 6, 5, 4, 3, and into tier 2 at $8.25 per unit
Customer 10 entered tier 7 on Nov. 2, 2009 ordered 1000 units at $14.25 each. As customers 11-13 entered their orders customer 10 was ratcheted down through tiers 7, 6, 5, 4, and into tier 3 at $9.00 per unit
Customer 11 entered tier 7 on Nov. 4, 2009 ordered 1000 units at $14.25 each. As customers 12-13 entered their orders customer 11 was ratcheted down through tiers 7, 6, 5, and into tier 4 at $11.25 per unit
Customer 12 entered tier 7 on Nov. 6, 2009 ordered 2500 units at $14.25 each. As customer 13 entered their order customer 12 was ratcheted down through tier 7 and into tier 6 at $13.50 per unit
Customer 13 entered tier 7 on Nov. 8, 2009 ordered 310 units at $14.25 each, and completed the target quantity for the production run.
The production triggers can be but are not limited to an end date that triggers the production run so long as the minimum quantity is reached. The production triggers can be but is not limited to a maximum quantity that is reached triggering the production run so long as the minimum timeframe is reached.

A secure platform or environment for inventors, collaborators, investors and manufacturers to connect to rapidly develop innovations and inventions by establishing a set of protocols to reduce the: challenges; fears, costs, risks, validation process and time to market for new inventions and innovations.

Challenges are addressed by identifying the necessary steps to bring an idea to fruition using a lean methodology in order to recruit a team of collaborators that have a documented process for being compensated, using a revenue sharing calculator, in exchange for their contribution to the development of the idea.

Conflicts often arise where money is concerned. That is why it is a priority to address this issue up front as quickly as possible. Many great ideas never make it into the marketplace because of legal issues arising from disagreements over money, small fortunes are spent with attorneys arguing over money that has not even been generated. We have provided a few standard models as well a customizable version. Make it a priority to get an agreement in place.

Everyone commits to the same timeline:

| | |
|---|---|
| Fast Track | 30 days |
| Medium Track | 90 days |
| Slow Track | 180 days |
| Long Track | 181 days+ |

These are suggestions for several different timeline options for the project management, other agreed upon timeframes can be utilized. When everyone is on the same page and giving the project the same priority things can go much smoother. Additionally, different projects have greatly different levels of complexity and a project managers experience in the given field can make all the difference in the world as to how the project flows.

The Inventor is automatically the default: Project Manager; Licensing Agent, and Collaborators. Each one of the skill sets is assigned a value based on the project. The Inventor can always subcontract for the necessary skills using traditional payment methods. Or he may choose to work with collaborators to fill these needs using the Revenue Sharing Model if the collaborators are willing to put their work at risk. There are several factors that come into play here. If the inventor has the resources to either do the work himself or pay to have it done, this is the way to maintain control of your project. However, most inventors are not in a position to pursue their idea without outside help. This help may be a skill set or the funds from an investor to allow the inventor to move forward without putting their personal financial security at risk.

Fears are reduced by having a standardized set of agreements or contracts that address but are not limited to: confidentiality (non-disclosure); collaboration, intellectual property ownership and development, compensation, manufacturing and licensing. Costs are reduced by utilizing the lean invention methodology processes by identifying some or all of the steps for adequate; development, design, creation of intellectual property, marketing, prototyping/manufacturing, crowd funding, and market feedback that can be secured for minimal costs (see FIG. 2).

Risks are reduced by providing or providing access to some or all of the tools and information to secure minimal viable intellectual property which may include but not limited to Provisional Patent Applications, Copyrights, trade secrets, domain names, social media names/handles, common law trademarks, and email addresses for free or at a minimal cost.

Validation processes include but are not limited to crowd sourcing for information, crowd sourcing for funding of the development of the invention. Crowd sourcing for the funding of the testing, revisions, production, packaging, shipping and fulfillment of the invention.

Time to market may be reduced by identifying and executing some or all of the steps identified above to launch a version of the invention that is marketable, reproducible, usable and validated by the consumer. The early adopters sales engine software program helps to drive validation by creating an incentive for consumers to commit to purchasing an invention prior to it going into production. Early adopters sales engine designed to allow all purchasers to enter the buying process at the same price. The Early Adopters Sales Engine software creates a financial incentive for an early adopter by dynamically ratcheting down the price paid by the earlier adopters as the volume of sales to the consumer or retailer based on a specific quantity or manufacturing time frame being filled. As the sales volume increases after one commits to purchase the more the price originally committed to is lowered dynamically. This can be done based on the individual purchases or based on predetermined quantities or tiers. The savings can be passed on in the form of cash refund, rebates, or credits for future purchases

FIG. 6 shows an exemplary Revenue Sharing Calculator. The Invention Revenue Sharing calculator demonstrates several things including but not limited to a). calculating the value contributed to the development of the invention b). determining the revenue share for the inventor(s), collaborator(s), investor(s) and other contributors, c). calculating the projected revenue based on annual sales, d) and calculating the revenue to be distributed to each of the inventor(s), collaborator(s), investor(s) and other contributors on a daily, weekly, annual, or life of the IP basis.

Challenges are addressed by identifying the necessary steps to bring an idea to fruition using a lean methodology in order to recruit a team of collaborators that have a documented process for being compensated, using a revenue sharing calculator, in exchange for their contribution to the development of the idea.

An inventor is entitled to 100% ownership of their intellectual property unless he has agreed otherwise, such as working for an employer whom he has assigned his rights in exchange for compensation. However inventors often keep their ideas locked away in their minds and never reduce them to practice, resulting in 100% ownership of an idea in a notebook or in their head instead of potentially valuable intellectual property.

If an inventor is wealthy or is employed by a company or Institution with a research and development team and an adequate budget they are in a position capitalize on the first inventor to file legislation. However, many inventors do not have the resources or skills necessary to bring their ideas to fruition in a timely manner. With the first inventor to file system if is important to do so. Therefore it is imperative to develop a method to help facilitate timely and collaborative development of inventions and innovations for those that do not have said resources readily available, so that they can be competitive with those who do.

The Revenue Sharing Calculator provides a method for determining the prelaunch value of an invention and helps determine the revenue share to be distributed to each of the collaborators based on contributing their services at risk. The calculator also provides annualized revenue share projections for the inventor and all of the collaborators who participate at risk in the development of the product. This allows the parties to see the potential long term value of contributing their work at risk and the parties can make a decision on the likelihood of success of the product before making the determination to provide their resources at risk. If the product is successfully licensed and sold in the marketplace the revenue is then collected distributed to the appropriate parties. If the product is not successfully licensed or sold in the marketplace the inventor and collaborators do not receive compensation.

FIG. 6 shows one Standardized Formula for determining the prelaunch value of an invention. a standardized formula can be advantageous for those who chose to avoid delays due to negotiating percentages. The calculator is fully adjustable to create a variety of custom formulas to meet the inventors preferences. The Assumptions to be entered into the calculator include but are not limited to:

1). Royalty: licensing percentage paid by licensee
2). Unit Cost: wholesale or licensing base price which royalty is based
3). Monthly Growth Rate: sales growth rate can be but not limited to monthly, quarterly, annually (based on year 1 baseline of assumption #5)
4). Royalty per Unit: licensing revenue per unit paid by licensee
5). Break Even # Units: the number of units needed to be sold based on the above assumptions in order for all collaborators recoup the dollar value of their contribution
6). $ Sales of Break Even: the dollar amount needed to be sold based on the above assumptions in order for all collaborators recoup the dollar value of their contribution
7). Annualized Growth Rate: based on the input into 3). listed above
Equity Breakdown: Inventor is expected to preform the following duties for this 51%

| | |
|---|---|
| 31% | Inventor: Responsible for establishing Provisional Patent |
| | Application, Common law trademarks, and other Intellectual |
| | Property. |
| 10% | Inventor: Acts as Project Manager and is the driving force in |
| | bringing idea to fruition. |
| 10% | Inventor acts as the Licensing Agent to secure licensing |
| | agreement(s). |
| 51% | Subtotal |

The revenue distribution management party is expected to collect and distribute the licensing revenue to the appropriate parties in exchange for this percentage.

| | |
|---|---|
| 10% | Allotted for managing the Revenue Sharing Distribution |
| 10% | Subtotal |

Example: the following collaborators percentage breakdown is as follows;

| | |
|---|---|
| 3% | Graphic Designer who makes a $5,000 contribution of at |
| | risk services |
| 8% | Engineer who makes a $12,000 contribution of at risk services |
| 9% | Sales who makes a $15,000 contribution of at risk services |
| 13% | Software who makes a $20,000 contribution of at risk services |
| 6% | Consultant who makes a $10,000 contribution of at risk services |
| 39% | Subtotal: collaborators revenue share which is divided among |
| | collaborators based upon the pro-rata dollar value of their |
| | contribution. |
| 100% | Total: Inventor 51%, Revenue Manager 10%, and |
| | Collaborators 39% |

### Collaborators $ Contribution is:

$62,000=39% of value of the collaborative contribution.
Therefore the pro-rata value of the remaining 61% would be calculated at $158,974=61% is the value assigned to the intellectual property and its management.

### Revenue Share:

Units: The number of units sold in year 1, 2, 3 and total for years 1-3 based on the assumptions entered above.
Sales: The dollar amount is sales for years 1, 2, 3 and total for years 1-3 based on the assumptions entered above.
My Cut: Is the royalty revenue share due to each participant per unit based on the dollar value of their contribution.
Yr 1 Payout: Shows dollar value of units sold based on the assumption #6 and the revenue share due to the inventors and collaborators.
Yr 2 Payout: Shows the revenue share due in dollars to the inventors and collaborators. The total dollar value of units sold based on the assumption for that year.
Yr 3 Payout: Shows the revenue share due in dollars to the inventors and collaborators. The total dollar value of units sold based on the assumption for that year.
Total: Shows the total units sold in years 1-3
Shows total dollars sales for years 1-3.
Total Payout: Shows the revenue share due in dollars to the inventors and collaborators for the total years 1-3.
Equity Share: Is a pie chart representing the Equity Breakdown.

FIG. 7 shows an exemplary School of Invention vs School of Hard Knocks. This graph demonstrates the risk in both time and financial resources associated with launching an invention. The green graph line indicates the licensing model which utilizes an established licensing partner. The red graph line indicates the startup model and cash flow challenges associated launching a new product via a startup. The grey graph line indicates the difference in costs of the in relation to the licensing model versus the startup model.

When used in a LAN environment, the computer may be connected to the local network through a network interface or adapter, which is one type of communications device. When used in a WAN environment, the computer 1100 typically includes a modem, a network adapter, or any other type of communications device for establishing communications over the wide area network. The system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an apparatus or device that utilizes or implements electronic, magnetic, optical, electromagnetic, infrared signal or other propagation medium, or semiconductor system. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

Described above, aspects of the present application can utilize the World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone lines, digital T-1 lines, T-3 lines, or other communications links known to those skilled in the art. Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. A web server may also include facilities for storing and transmitting application programs for execution on a remote computer. Likewise, a web server may also include facilities for executing scripts and other application programs on the web server itself.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method to commercialize a product or service at an early stage, comprising: conceiving of a new concept and converting the new concept into an intellectual property (IP) asset; forming a team to develop the new concept using a computer; determining contributions from each member of the team and assigning a profit sharing percentage to each contributing member; and developing the new concept and bringing the product or service to a marketplace as a new business venture.

2. The method of claim 1, wherein the intellectual property asset comprises a provisional patent application, comprising generating the IP asset using a patent workflow software.

3. The method of claim 1, comprising applying a standardized set of contracts and agreements prior to disclosure of the intellectual property or idea to any relevant parties including non-inventors.

4. The method of claim 1, comprising applying an Invention Revenue Sharing calculator for determining the value contributed to the development of the invention; determining the revenue share for the inventor(s), collaborator(s), investor(s) and other contributors, calculating the projected revenue based on annual sales, and calculating the revenue to be distributed to each of the inventor(s), collaborator(s), investor(s) and other contributors on a daily, weekly, annual, or life of the IP basis.

5. The method of claim 1, comprising Invention Matrix which is an interactive suite of web based tools and resources pertaining to the registration and membership of participating parties, database of the participating parties, intellectual property resources, marketing resources, manufacturing and sourcing resources, trademark copyright and patent owners (TCAPO) resources and management, distribution resources, sales resources, social and professional network resources, and crowdsourcing and crowd funding to end users and wholesale customers.

6. The method of claim 1, comprising applying an Early Adopters Sales Engine to create a financial incentive to an early adopter by dynamically reducing a price paid by the early adopters as a function of volume of sales to the consumer or retailer based on a specific quantity or manufacturing time frame being filled.

7. The method of claim 1, comprising dynamically reducing price as sales volume increases.

8. The method of claim 1, comprising passing volume savings to buyers as a cash refund, rebate, or credit for future purchases.

9. The method of claim 1, comprising providing annualized revenue share projections for an inventor and each collaborator participating in the development of the product to understand potential long term value of contributing their work at risk, wherein each party makes a decision on a likelihood of success of the product before making a determination to participate in the new business venture.

10. The method of claim 1, comprising modeling royalty, unit cost, monthly grow rate, unit royalty, break even unit, break even sales, and annualized growth rate.

11. A system to commercialize a product or service at an early stage with a team to develop the new concept, comprising: a computer for receiving a new concept and for converting the concept into an intellectual property (IP) asset, computer code for determining contributions from each member of the team and assigning a profit sharing percentage to each contributing member; and computer code for developing the new concept and bringing the product or service to a marketplace as a new business venture.

12. The system of claim 11, wherein the intellectual property asset comprises a provisional patent application, comprising a patent workflow software to generate the IP asset.

13. The system of claim 11, comprising computer code for applying a standardized set of contracts and agreements prior to disclosure of the intellectual property or idea to any relevant parties including non-inventors.

14. The system of claim 11, comprising an Invention Revenue Sharing calculator for determining the value contributed to the development of the invention;
determining the revenue share for the inventor(s), collaborator(s), investor(s) and other contributors based on the value contributed by that contributing party, calculating the projected revenue based on annual sales or other desired timeframe, and calculating the revenue to be distributed to each of the inventor(s), collaborator(s), investor(s) and other contributors on a daily, weekly, annual, or life of the IP basis, or any other desired timeframe.

15. The system of claim 11, comprising an Invention Matrix which is an interactive suite of web based tools and resources pertaining to the registration and membership of participating parties, database of the participating parties, intellectual property resources, marketing resources, manufacturing and sourcing resources, trademark copyright and patent owners (TCAPO) resources and management, distribution resources, sales resources, social and professional network resources, and crowdsourcing and crowd funding to end users and wholesale, which is an interactive suite of web based tools that allow for the online collaboration, development, design, prototyping, testing, production sourcing, management, marketing, sales, shipping, and fulfillment of the invention.

16. The system of claim 11, comprising an Early Adopters Sales Engine to create a financial incentive to an early adopter by dynamically reducing a price paid by the early adopters as a function of volume of sales to the consumer or retailer based on a specific quantity or manufacturing time frame being filled.

17. The system of claim 11, comprising computer code for dynamically reducing price as sales volume increases.

18. The system of claim 11, comprising computer code for passing volume savings to buyers as a cash refund, rebate, or credit for future purchases.

19. The system of claim 11, comprising computer code for providing annualized revenue share projections for an inventor and each collaborator participating in the development of the product to understand potential long term value of contributing their work at risk, wherein each party makes a decision on a likelihood of success of the product before making a determination to participate in the new product licensing venture.

20. The system of claim 11, comprising computer code for modeling royalty, unit cost, monthly grow rate, unit royalty, break even unit, break even sales, and annualized growth rate.
